(19) United States
(12) Patent Application Publication
(10) Pub. No.: US 2017/0337408 A1
(43) Pub. Date: Nov. 23, 2017

(54) SIGN, VEHICLE NUMBER PLATE, SCREEN, AND AR MARKER INCLUDING BOUNDARY CODE ON EDGE THEREOF, AND SYSTEM FOR PROVIDING ADDITIONAL OBJECT INFORMATION BY USING BOUNDARY CODE

(71) Applicant: KUMOH NATIONAL INSTITUTE OF TECHNOLOGY INDUSTRY-ACADEMIC COOPERATION FOUNDATION, Gyeongsangbuk-do (KR)

(72) Inventor: Jae Pil KO, Gyeonggi-do (KR)

(21) Appl. No.: 15/505,057

(22) PCT Filed: Aug. 18, 2015
(86) PCT No.: PCT/KR2015/008585

§ 371 Date: Feb. 17, 2017

(30) Foreign Application Priority Data
Aug. 18, 2014 (KR) 10-2014-0107080
Aug. 18, 2014 (KR) 10-2014-0107082
Oct. 10, 2014 (KR) 10-2014-0136729
Oct. 10, 2014 (KR) 10-2014-0136731

(51) Int. Cl. G06K 7/14; G06K 9/20; G06K 9/46

(52) U.S. Cl. CPC G06K 7/1452; G06K 9/46; G06K 7/1443; G06K 9/20

(57) ABSTRACT

A system of the present invention for providing additional object information by using a boundary code on an edge comprises: a sign having an edge to which a boundary code is provided; and a smart device which converts the boundary code into additional object information and visually, acoustically, and sensately provides the additional object information. The present invention facilitates pattern recognition even at a long distance and there is almost no probability of the pattern recognition failing.

### TECHNICAL FIELD

The present invention relates to a sign, a vehicle number plate, a screen, and an AR marker having a boundary code on an edge thereof, and a system for providing additional object information using the boundary code. In particular, the present invention relates to a sign, a vehicle number plate, a screen, and an AR marker that may prevent an identification code from obscuring a user's view and also from conflicting with original object information by placing the identification code in an edge area, which is a blind spot, of the sign in the sign and system for long-distance-vision-based object information recognition, may facilitate clear pattern recognition by configuring an identification code in a line-type image pattern, may even facilitate pattern recognition from a long distance by arranging a line pattern in an edge area, and may provide a variety of additional object information by classifying a line pattern according to a presence, length, thickness, or type of the pattern, and a system for providing additional object information using a boundary code.

### BACKGROUND ART

Generally, a quick response (QR) code is a two-dimensional matrix-type barcode that represents information in a black-and-white grid pattern and was developed for logistics management by Denso Wave Inc., which is a subsidiary of Japan's Toyota, in 1994. Its name originates from the registered trademark “Quick Response” of Denso Wave Inc. An existing vertical pattern barcode can store only numbers while the QR code is an enhanced technique that may even store characters to infinitely increase the amount of information and also may connect to the Internet to show detailed product information, image, video, etc. Since the QR code is a two-dimensional matrix-type code in which small square points that are equal in width and length are disposed, the QR code can be recognized in any direction of 360° and may record more information. Such QR codes are displayed on an advertisement, a signboard, or the like and are utilized to deliver information.

Recently, QR codes have a tendency to be displayed on screens in the form of computer graphics (CG) in TV broadcasting programs as well as printouts or to be exposed using DTV data broadcasting technology.

However, QR codes have limitations in that they are mainly utilized when close-up imaging is possible as shown in FIG. 1. For example, if a QR code printed on a signboard is imaged from a far distance as shown in FIG. 2, it is often difficult to recognize the code because an area of the QR code decreases as the distance increases.

In particular, when the above-described QR code is provided at one side of a signboard, the QR code obscures a consumer's view.

Referring to FIG. 3, in modern society, the Internet is being used as a space in which people may share information as producers or consumers of information. In the future, an Internet of things (IoT) era is coming in which even objects around us, such as electronics, sensors, etc., may be connected to a network to share information regarding environments around the objects and information regarding the objects themselves Also, the number of devices that support the IoT is increasing every day.

That is, when communication, interaction, and information sharing between a person and a person, between a person and an object, and between an object and an object are possible through the IoT, an intelligent service in which an object performs a determination for itself is possible, and also the IoT may be an infrastructure through which corporations can save costs and support green IT for green growth.

To this end, unique information regarding various kinds of objects should be able to be sensed and monitored. The IoT cannot be realized properly when information regarding each object cannot be monitored. Several methods are used to monitor unique information of an object.

For example, when a wastebasket is connected to the Internet to sense and monitor a state of the wastebasket as shown in FIGS. 3 and 4, an ID for the wastebasket may be assigned, and RFID technology or GPS technology may be used to recognize the ID.

With RFID technology, a wastebasket may transmit its own ID to a reader installed in a garbage truck, and the reader may receive the ID of the wastebasket, connect to the wastebasket, and acquire relevant information (a location, maximum capacity, and current capacity of the wastebasket).

Likewise, with GPS technology, it is possible to acquire an ID of a wastebasket through location information of the wastebasket and receive information regarding the wastebasket.

However, for the above-described RFID technology or GPS technology, since an RFID reader should be installed in each garbage truck, management costs of the RFID reader and an antenna are borne. Also, since GPS location information has low GPS resolution in downtown areas because of high-rise buildings, its associated information cannot be reliable.

### DETAILED DESCRIPTION OF THE INVENTION

### Technical Problem

Accordingly, the present invention is designed to solve problems of the conventional technology as described above. An objective of the present invention is to provide an additional object information provision system having an identification code for sensing and monitoring unique information of objects in order to enable information between the objects to be shared through the Internet of things (IoT).

Another objective of the present invention is to provide an additional object information provision system for providing additional object information in which a code is provided on an entire edge of a sign such that vision-based code recognition is possible even from a long distance.

Another objective of the present invention is to provide an additional object information provision system for providing a user with additional object information that is in conflict with original object information without obscuring the user's view.

Another object of the present invention is to provide an additional object information provision system that facilitates configuration of an image pattern so that recognition of a code into which additional object information is encoded does not fail.

Another object of the present invention is to provide an additional object information provision system capable of code recognition by utilizing an edge corner contour of a sign.

Another object of the present invention is to provide an additional object information provision system capable of code recognition by recognizing only whether a code is present at a specific position.

Another object of the present invention is to provide an additional object information provision system capable of a plurality of code combinations so that additional object information is provided like Internet information.

### Technical Solution

According to a feature of the present invention for accomplishing the above-described objectives, a sign of the present invention includes a sign area in which original object information is disposed and an edge area in which additional object information of the original object information is disposed along a boundary of the sign area in the form of an identification code. Here, the identification code of the edge area is a boundary code.

According to another feature of the present invention, an additional information provision system of the present invention includes a sign having a boundary code provided on an edge and a smart device configured to convert the boundary code into additional object information and visually, acoustically, or sensately indicate the additional object information.

### Advantageous Effects of the Invention

As described above, according to the configuration of the present invention, the following effects can be expected.

First, a user is not inconvenienced by utilizing an edge/corner space of a sign on which the user's view is not focused without occupying the center of the sign like a quick response (QR) code does. In particular, since original object information and additional object information are disposed in a center area and an edge area, they are not in conflict. Thus, a visually impaired person may receive the additional object information by only capturing a sign using his/her smart device, and a normal person has no difficulty in recognizing the original object information because the additional object information is positioned in the edge area.

Second, there is almost no probability of pattern recognition failure when only recognizing a presence or absence of a specific image pattern.

Third, it is possible to provide even detailed additional object information without special limitations because many code combinations are possible depending on a presence, length, thickness, and type of a pattern and a presence of an icon combined with a pattern. For example, since educational objects may have their own identification codes, it is possible to provide unique content regardless of the amount of information for each of the educational objects.

### DESCRIPTION OF THE DRAWINGS

FIG. 1 shows an example in which a quick response (QR) code is utilized when close-up imaging is possible according to a conventional technology.

FIG. 2 shows an example in which a QR code is utilized when long-distance imaging is possible according to the conventional technology.

FIG. 3 shows an example of object information for the Internet of things (IoT) according to the conventional technology.

FIG. 4 shows an example of applying RFID technology and GPS technology for sensing or monitoring object information in the IoT according to the conventional technology.

FIG. 5 is a block diagram of a system for providing additional object information according to the present invention.

FIG. 6 is a block diagram of a smart device that provides additional object information according to the present invention.

FIG. 7 is a block diagram of an identification code interpretation APP according to the present invention.

FIGS. 8 to 12 are front views of a rectangular sign in which a boundary code is provided on an edge according to the present invention.

FIG. 13 is a front view of a triangular sign in which a boundary code is provided on an edge according to the present invention.

FIG. 14 is a front view of a circular sign in which a boundary code is provided on an edge according to the present invention.

FIG. 15 is a flowchart showing a method of providing additional object information according to the present invention.

FIG. 16 is a block diagram of a system for recognizing a vehicle number plate according to the present invention.

FIG. 17 is a block diagram of an apparatus for recognizing a vehicle number plate according to the present invention.

FIGS. 18 to 20 are front views of a vehicle number plate including a boundary code on an edge thereof according to the present invention.

FIG. 21 is a block diagram showing a configuration of a system for providing additional content information according to the present invention.

FIGS. 22 and 23 are front views of examples of an identification code for providing additional content information of the present invention.

FIG. 24 is a conceptual view of an example of a broadcast application example of an identification code according to the present invention.

FIG. 25 is a conceptual view of an AR providing system according to the present invention.

FIGS. 26 and 27 are front views of an AR marker according to the present invention.

FIG. 28 is a block diagram of an AR provision apparatus according to the present invention.

FIG. 29 is a block diagram of a marker recognition module according to the present invention.

FIGS. 30 and 32 are front views of various examples of an AR marker according to the present invention.

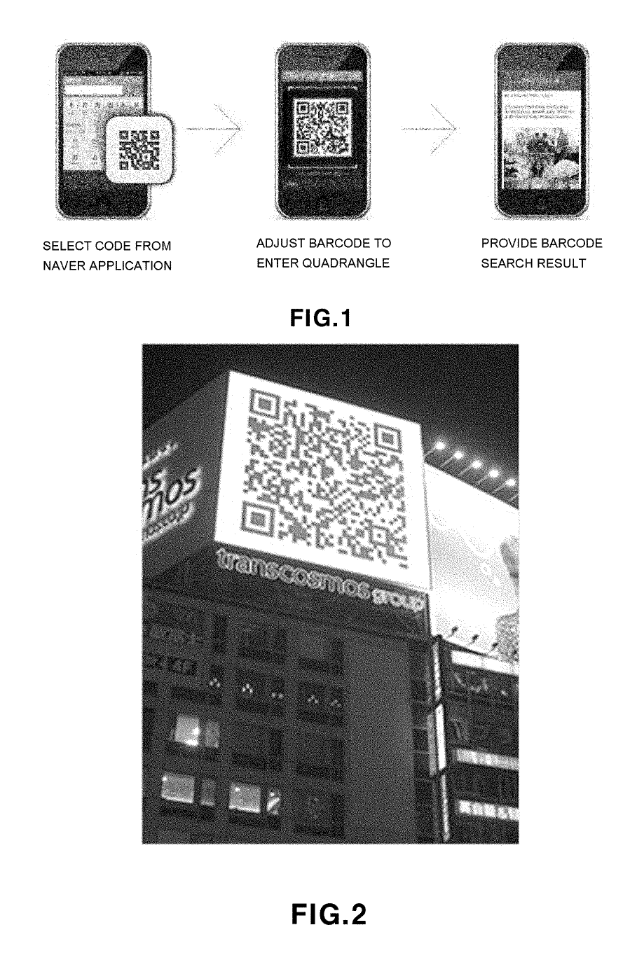

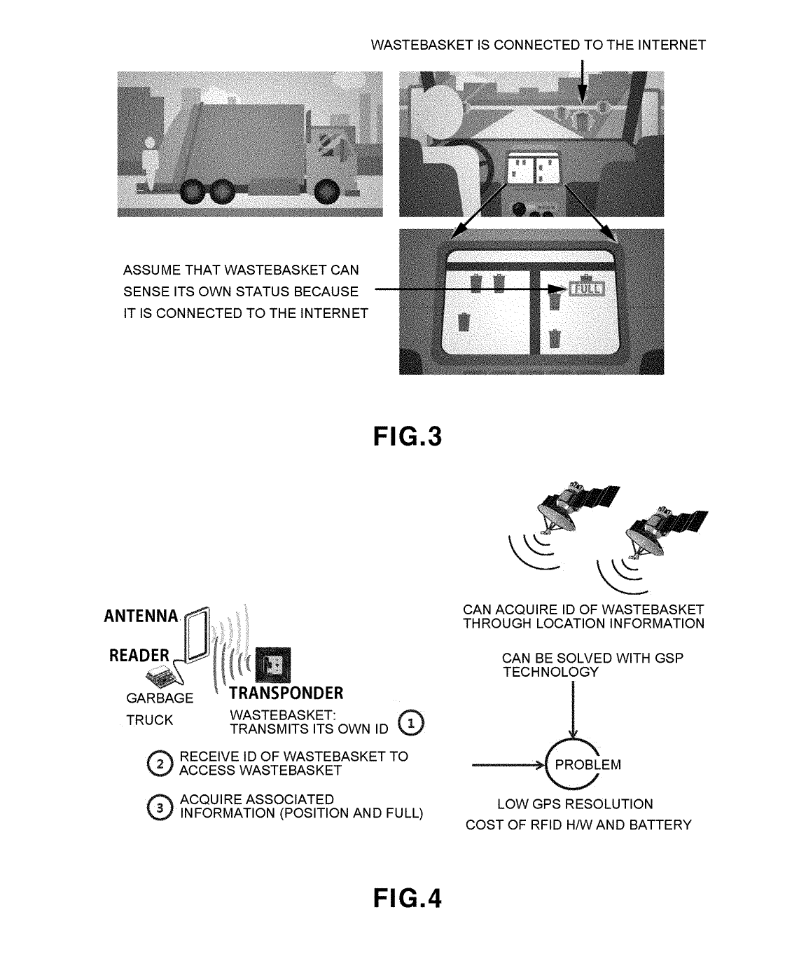

### MODE OF THE INVENTION

Advantages and/or features of the present disclosure, and implementation methods thereof will be clarified through the following embodiments described with reference to the accompanying drawings. The present disclosure may, however, be embodied in different forms and is not to be construed as limited to the embodiments set forth herein. Rather, these embodiments are provided so that this disclosure is thorough and complete, and fully conveys the scope of the present disclosure to those skilled in the art. Sizes and relative sizes of layers and areas in the drawings may be exaggerated for clarity of illustration. Like reference numerals refer to like elements throughout.

A preferred embodiment of a system having the above configuration and configured to provide additional object information using a boundary code provided on an edge of a sign according to the present invention will be described in detail below with reference to the accompanying drawings.

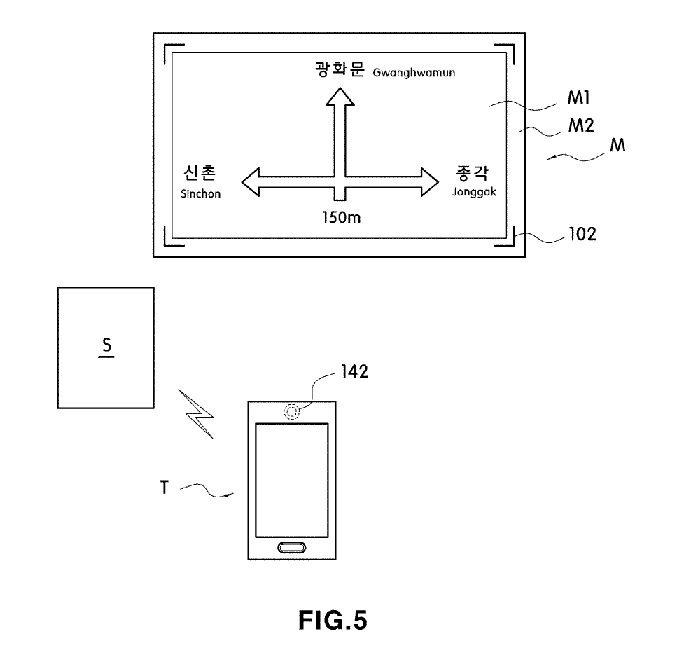

Referring to FIG. 5, an additional object information system 100 using a boundary code provided on an edge of a sign of the present invention includes a sign M having an identification code 102 provided on an edge thereof and a smart device T configured to convert the identification code into additional object information. The additional object information system 100 may further include an object information server S configured to generate and store separate additional object information in real time and provide the additional object information to the smart device T.

The sign M refers to a cover for visually indicating object information. For example, a road traffic sign M may refer to a cover for indicating various cautions, regulations, and indications associated with road traffic, a safety sign M may refer to a cover for indicating dangerous places, materials, peripheral details, etc., and a price sign M may refer to a cover for indicating price information of an object. The sign M may include educational materials. The sign M may include a vehicle number plate. The sign M of the present invention may include an object of an Internet of things (IoT) configured to acquire information through its own sensor or communication.

Such a sign M may be variously installed or transacted depending on a peripheral environment thereof. For example, the sign M may be transacted alone or fixed by a separate support. For example, the sign M may be an object itself or may be used in accordance with another object.

Such a sign M includes a sign area M1 in which original object information is disposed and an edge area M2 in which additional object information of the original object information is disposed along a boundary of the sign area M1 in the form of the identification code 102.

Accordingly, when the sign M is a road traffic sign, the original object information may be information that indicates regulations and instructions associated with road traffic, and the additional object information may be road periphery information. Alternatively, when the original object information is braille information for a visually impaired person, the additional object information may be additional object information obtained by acoustically or sensately substituting visual object information.

The smart device T is a mobile terminal such as a smart phone, a cellular phone, an iPhone, a notebook computer, etc., and may include any other terminal having various communication functions such as mobile network communication or wireless short-range communication. Here, it is assumed that a scanner or a camera module 142 is mounted on the smart device T. For example, when the IoT monitors an inside of a house or continuously shows a situation of the house, the camera module 142 may include a CCTV installed in the house.

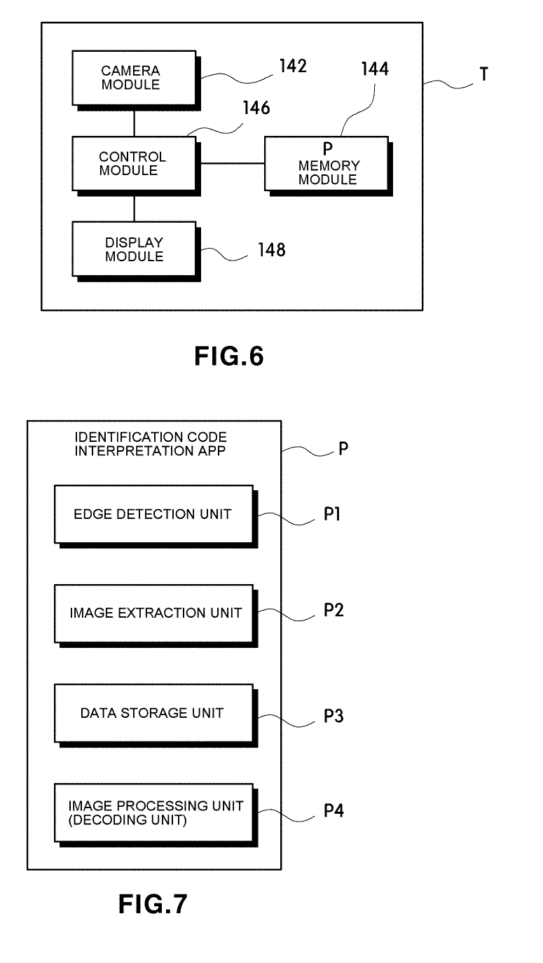

Referring to FIG. 6, the smart device T includes the camera module 142 configured to scan the identification code 102 from the sign M according to a control signal of a control unit to be described below, a memory module 144 configured to store an identification code interpretation APP in addition to a default program for controlling an overall operation of the smart device T, a control module 146 configured to drive the identification code interpretation APP or perform direct network communication with the object information server S to convert the identification code 102 into additional object information, and a display module 148 configured to show or tell the additional object information to a viewer.

Accordingly, the additional object information is a combination of characters, numbers, symbols, or pictures that may be directly recognized by a user. Alternatively, the additional object information may be a combination of spoken expressions. The additional object information may include video information.

Referring to FIG. 7, the identification code interpretation APP includes an edge detection unit P1 configured to detect the edge area M2 of the sign M, an image extraction unit P2 configured to acquire a pattern image of the identification code 102 from the edge area M2 and extract a pattern image from the acquired identification code 102, a data storage unit P3 configured to store code data corresponding to the above-described pattern image, and an image processing unit P4 configured to generate additional object information from the pattern image using prestored code data. Here, the code data is a password for converting the pattern image into the additional object information.

The edge detection unit P1 may perform a function of rotating and aligning the edge area M2 when the edge area M2 is not aligned, for example, is tilted, and also a function of adjusting a size of the sign M to the same size environment even when the sign M has a different size, as a pre-operation to detect the edge area M2 of the sign M and extract only the pattern image from the detected edge area M2.

Although not shown, the additional information server S may include an object information production unit configured to generate the additional object information, an object information storage unit configured to store the additional object information, etc. Also, the object information server S may define the identification code 102 and may convert (encode) additional object information of the sign M into the identification code 102.

As described above, according to the system 100 for providing additional object information using a boundary code provided on an edge of a sign of the present invention, the smart device T having the camera module 142 mounted thereon may provide a service for providing the additional object information to a user using the identification code interpretation APP.

The present invention may directly decode the additional object information through the code data stored in the smart device T, and also may perform network communication with the object information server S to receive the additional object information from the object information storage unit.

In the present invention, the identification code 102 includes a pattern image. Here, the pattern image may be designed in the form of a boundary code that may be disposed in the edge area M2 of the sign M.

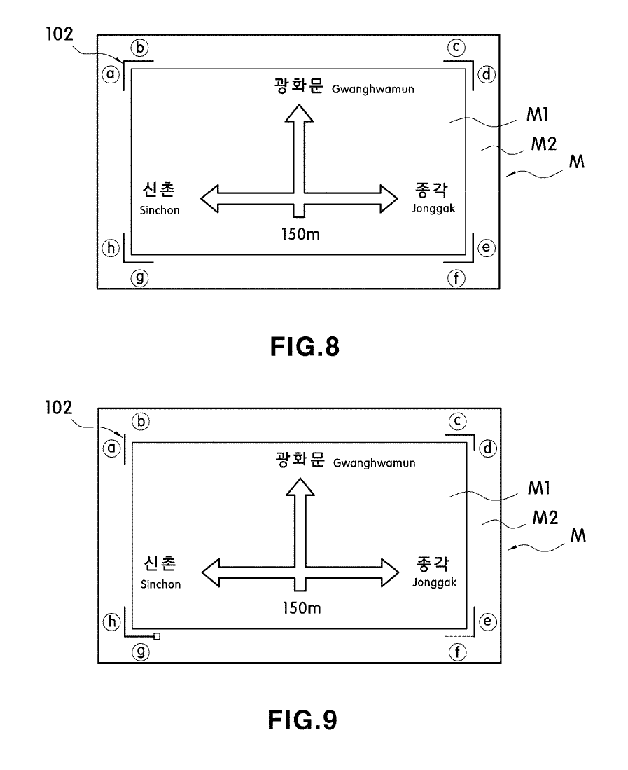

As shown in FIGS. 8 to 10, the boundary code may be placed on an edge of the sign M, in particular, on a corner of the sign M, so that the pattern image does not obscure a user's view.

The sign M may be configured as a rectangular shape.

Referring to FIG. 8, the boundary code may be placed on a corner of the sign M. In this case, the boundary code may be designed as a character type “L” having directivity depending on a position of the corner. In this case, the boundary code may be a line pattern.

Accordingly, each corner is configured as a combination of a presence or absence of a “—” pattern and a presence or absence of a “|” pattern. Since the combination includes a case in which both the “—” pattern and the “|” pattern are present, a case in which only the “—” pattern is present, a case in which only the “|” pattern is present, and a case in which neither the “—” pattern nor the “|” pattern is present, each of the corners may have two bits (2²) of information. Four corners may have eight bits (2⁸) of information. Accordingly, one sign M having four corners may express 255 pieces of information by default.

For example, a presence refers to “1,” and an absence refers to “0.” When an “L” pattern is present on each of the four corners, this indicates “11 11 11 11” and has a value of “255” (in this case, a case in which there is no pattern at the four corners is excluded). When the “L” pattern is present on only a first corner, this indicates “11 00 00 00” and has a value of “2.”

Some of the patterns may be used as reference points for identifying the top, the bottom, the left side, and the right side of the sign M.

Since recognition of whether there is a line pattern on each corner of the sign M is minimally sufficient, there is little probability of pattern recognition failure.

The above line pattern is expandable through pattern deformation.

Referring to FIG. 9, an identification code value may increase by further including a length, thickness, color, or type (e.g., a solid line/dotted line or a straight line/concave-convex line) of a line or a presence/position of an icon combined with a line in addition to a presence of the line.

For example, the first corner is coded as a combination of a presence □ and an absence □ of a line, the second corner is coded as a combination of a long line □ and a short line □, the third corner is coded as a combination of a solid line □ and a dotted line □, and the fourth corner is coded as a combination of a presence □ and an absence □ an icon. In addition, a combination of a thick line and a thin line, a combination of various color lines, or the like may be considered.

For example, when a length of a line (a long line and a short line), a type of line (a solid line and a dotted line), and a presence of an icon combined with a line (the presence or absence of the icon) in addition to a presence of the line (the presence or absence of the line) are further included, it is possible to identify a total of 32 bits (2³²=up to 4,294,967,296).

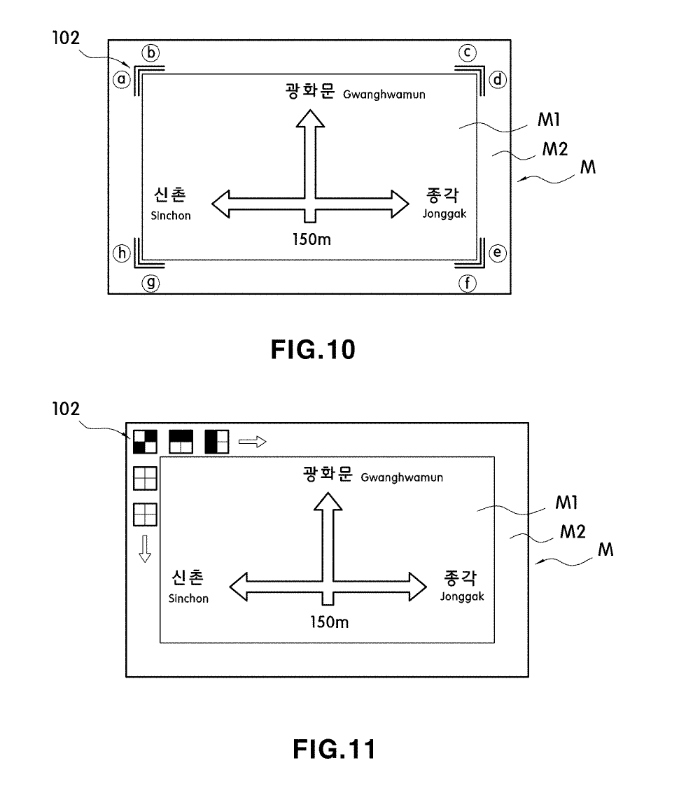

The above line pattern can be further expanded through duplication of the pattern line. Referring to FIG. 10, when the line pattern of the above-described first expansive embodiment is expanded to two lines, up to 32 bits×32 bits (2³²×2³²) of content information can be secured. Since information of such a size is comparable to an IPv6 address, the information can be used as an Internet address.

Referring to FIG. 11, a boundary code is placed on an edge of the sign M. At this time, the boundary code may include a block pattern.

The block pattern may be configured as a combination of multiple blocks having no directivity. For example, the block pattern may be a combination of a total of four blocks each having a fixed position value. Each block contains “0” or “1,” and thus may include 4 bits (2⁴) of information, that is, information of 0 to 15.

When such N 4-bit block patterns are arranged on an edge, it is possible to express information of N×4 bits (2⁴). Some of the blocks may be reference points for identifying the top, the bottom, the left side, and the right side of the sign M.

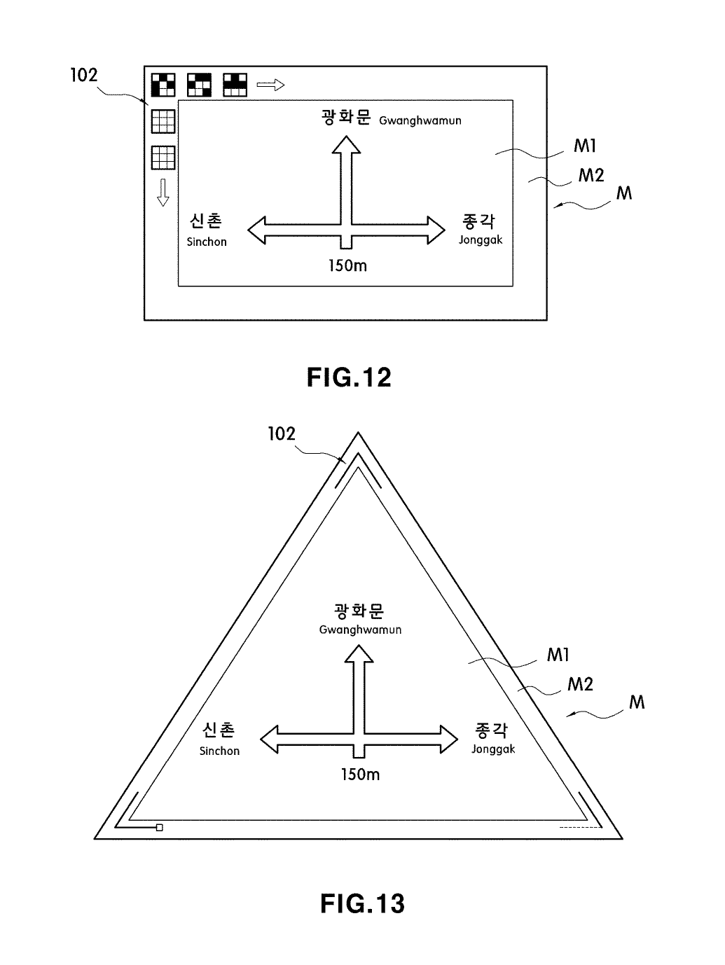

Referring to FIG. 12, as another example, the block pattern may be a combination of a total of 9 blocks. Likewise, each block contains “0” or “1,” and thus may include 9 bits (2⁹) of information, that is, information of 0 to 511.

The sign M may be triangular.

Referring to FIG. 13, a boundary code may be placed on each of the edges of the sign M.

Accordingly, when the sign M is rectangular, triangular, or in the shape of a polygon having a corner, the boundary code may be disposed by utilizing an edge area M2 of the corner.

The sign M may be circular.

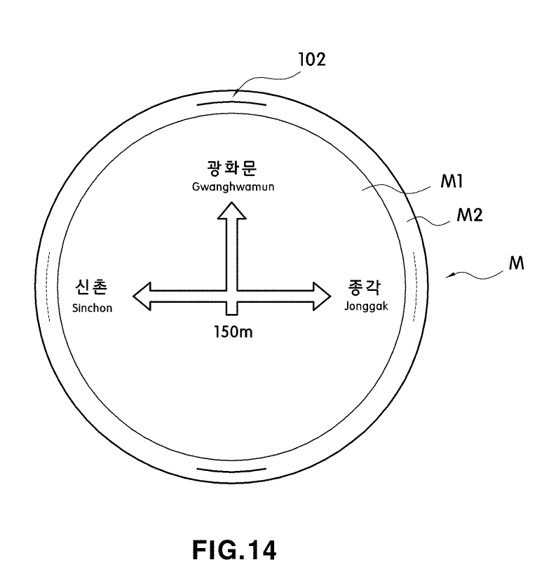

Referring to FIG. 14, a boundary code is placed on an edge of the sign M.

Accordingly, regardless of the shape of the sign M, the boundary code may be disposed in the edge area M2 of the sign M to display object information.

Referring again to FIG. 5, when a user is visually impaired, the user may be provided with additional object information (e.g., road information) on a road. A visually impaired person images surroundings with his or her smart device T while changing direction. When the smart device T images a sign M installed near the visually impaired person, the smart device T recognizes the identification code 102 of the sign M and expresses additional object information of the sign M by sound or the like. For example, the smart device may deliver voice guidance “The imaged sign M is a road traffic sign. You are facing toward Gwanghwamun. Go to the left for Sinchon and go to the right for Jonggak.”

A method of providing additional object information using a boundary code provided on an edge of a sign will be described below.

First, additional object information is encoded on the sign M. The object information server S designs a boundary code as described above.

Next, the additional object information is decoded using the smart device T.

An identification code interpretation APP is driven to receive the additional object information. When the identification code interpretation APP is registered in the object information server S and a user images or scans an identification code, a separate QR code or the like of the sign M using a camera module, it is not difficult to install the identification code interpretation APP. Alternatively, when the object information server S is linked with a well-known site such as an APP store or the T-Store, a viewer may search the app store or a web space for the identification code interpretation APP and directly download and install the identification code interpretation APP. For convenience, when the identification code interpretation APP is downloaded, the identification code interpretation APP may be directly activated by placing its associated icon on a home screen.

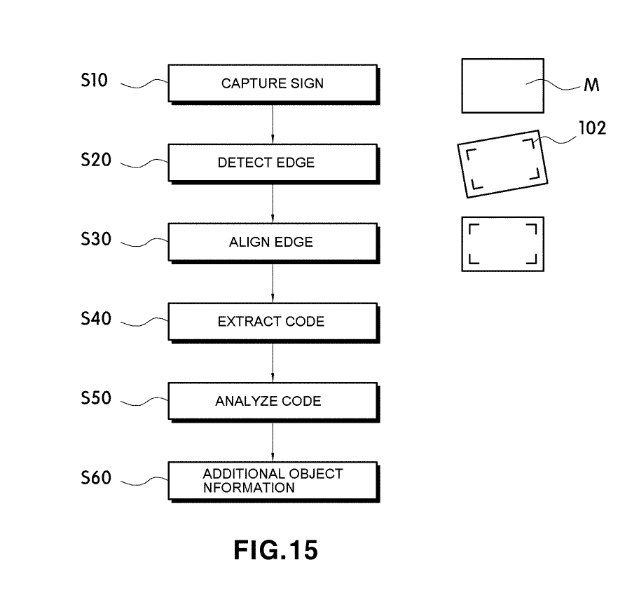

Referring to FIG. 15, when the identification code interpretation APP is driven, the sign M is imaged using the camera module 142 of the smart device T (S10).

In this case, the edge detection unit P1 is activated to detect four corners of the sign M (S20). The sign M is aligned (rotational alignment/size alignment) (S30). The screen M is aligned in a clockwise or counterclockwise direction regardless of an angle at which the sign M is imaged. Also, since the sign M may have various sizes, the size as well as the rotational direction may be aligned before the identification code 102 is extracted.

The identification code 102 is extracted (S40). When an edge of the sign M is detected and the sign M is aligned, a pattern image of the identification code 102 is extracted from the edge area M1 using the image extraction unit P2.

The identification code 102 is interpreted (S50). The identification code 102 is converted into additional object information (S60). The image processing unit P4 interprets the pattern image using code data of the data storage unit P3 and generates additional object information from the pattern image. For example, when the pattern image is analyzed and has default information, the smart device T itself may generate the additional object information. Alternatively, when the pattern image has video information, the smart device T may receive the additional object information from an object information storage unit of the object information server S.

A system for recognizing a vehicle number using a boundary code provided on an edge of a vehicle number plate according to another embodiment of the present invention will be described below.

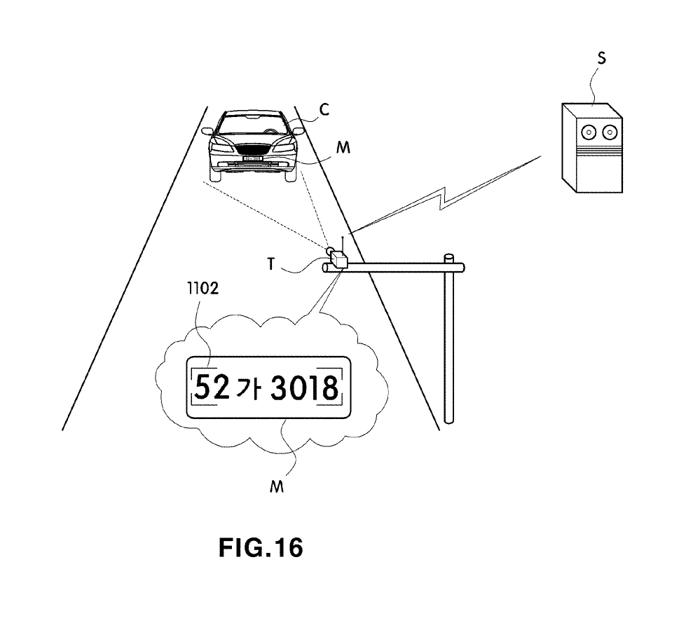

Referring to FIG. 16, a vehicle number recognition system of the present invention includes a number plate in which an identification code 1102 is provided on an edge thereof and a vehicle number recognition apparatus T configured to convert the identification code 1102 into vehicle number information. The vehicle number recognition system may further include a general vehicle information server S configured to generate and store vehicle number information or additional information associated with the vehicle number information in real time and provide the information to the vehicle number recognition apparatus T.

A number plate M refers to a cover for visually indicating number information of a vehicle C. Conventionally, the vehicle number information may be configured as a combination of numbers and characters that may be directly recognized by a user.

The number plate M includes a sign area M1 in which the above-described vehicle number information having a combination of numbers and characters is disposed and an edge area M2 in which original vehicle number information is disposed along a boundary of the sign area M1 in the form of the identification code 1102.

The vehicle number recognition apparatus T itself may generate, store, or output vehicle number information, and also may transmit the vehicle number information to the outside through a communication unit. For example, the vehicle number recognition apparatus T may include a mobile terminal such as a smartphone, a cellular phone, an iPhone, and a notebook computer. Accordingly, any terminal having various communication functions such as mobile network communication or wireless short-range communication may be included. However, it is assumed that a scanner or a camera module is mounted on the vehicle number recognition apparatus T.

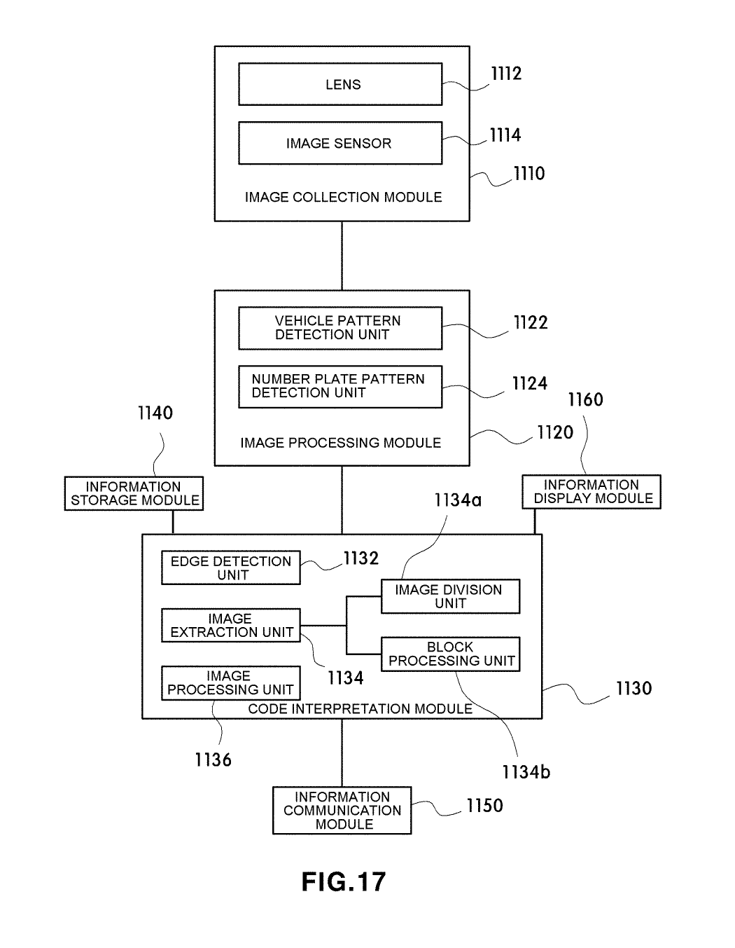

Referring to FIG. 17, the vehicle number recognition apparatus T includes an image collection module 1110 and configured to collect image data of the vehicle C including the number plate M, an image processing module 1120 configured to process the collected image data to detect the number plate M, and a code interpretation module 1130 configured to extract number information from the number plate M.

The vehicle number recognition apparatus T may further include an information storage module 1140 configured to store the number information, an information display module 1150 configured to show or tell the number information to a user, and an information communication module 1160 configured to transmit the number information to the outside.

The image collection module 1110 may be a camera module including a lens configured to receive an optical signal for an image of the vehicle C including the number plate M, and an image sensor configured to change the received optical signal into an electric image signal needed to process the image to generate image data. In this case, when the identification code 1102 includes a color pattern, the image collection module 1110 may be a color camera module that further includes a color filter array composed of an RGB filter.

The image sensor 1114 may include a charged coupled device (CCD) image sensor, a complementary metal oxide semiconductor (CMOS) image sensor, etc. Also, the above-described color camera module may include an image camera, a web camera, or various digital cameras as well as the CCD and the CMOS.

The image processing module 1120 includes a vehicle pattern detection unit 1122 configured to detect a pattern of the vehicle C from the image data, and a number plate pattern detection unit 1124 configured to detect a specifically-shaped pattern of the number plate M from the pattern of the vehicle C.

The vehicle pattern detection unit 1122 may remove noise from the image data by using a local average filter so that a boundary of the specifically-shaped pattern of the vehicle C is highlighted, and may correct a brightness of the specific pattern using spectrum equalization. For example, the vehicle pattern detection unit 1122 may perform correction for removing a shadow effect or may perform equalization so that a gray pattern contrast value has a certain contrast value distribution after changing a specific color pattern to a gray pattern.

The number plate pattern detection unit 1124 may detect only the pattern of the number plate M from the pattern of the vehicle C. For example, the number plate pattern detection unit 1124 may use a knowledge-based algorithm such as a vehicle number plate recognition algorithm to detect only the pattern of the number plate M from the pattern of the vehicle C on the basis of a fact that the number plate M is approximately rectangular, is placed at the center of the entire vehicle C, and has a certain size ratio compared to the entire vehicle C.

In another method, when colored (including black) numbers on a white background are repeated in series, this may be recognized as the number plate M. Alternatively, in still another method, the number plate pattern detection unit 1124 may use a DB in which shape information and size information of the number plate M of the vehicle C is stored to perform comparison with sample information stored in the DB and detect the pattern of the number plate M.

When the vehicle C is not aligned with the camera module, the number plate pattern detection unit 1124 may extract an angle tilted to the left or right and calculate a direction value of the corresponding vehicle. For example, when the pattern of the number plate M is asymmetric, the number plate pattern detection unit 1124 may reflect the direction value to recognize the identification code 1102 of the number plate M. The number plate pattern detection unit 1124 may perform a function of rotating and aligning the number plate M when the number plate M is not aligned, for example, is tilted, and also a function of adjusting a size of the number plate M to the same size environment even when the number plate M has a different size.

The code interpretation module 1130 includes an edge detection unit 1132 configured to detect the edge area M2 of the number plate M, an image extraction unit 1134 configured to acquire a pattern image of the identification code 1102 from the edge area M2 and extract a pattern image from the acquired identification code 1102, and an image processing unit 1136 configured to generate number information from the pattern image by using a DB in which code data corresponding to the above-described pattern image is stored. Here, the code data stored in the DB is a password for converting the pattern image into the number information.

The image extraction unit 1134 includes an area division unit 1134a configured to divide the edge area into code blocks B (e.g., four corner blocks) and a block processing unit 1134b configured to process an identification code for each of the code blocks B. Accordingly, since the edge area includes the four corner blocks and the code blocks correspond to the four corner blocks, the block processing unit 1134b processes the identification code 1102 for each of the four corner blocks.

The vehicle number recognition apparatus T of the present invention may be installed in an image recording apparatus of a vehicular black box or may be a vehicular black box itself. As described above, the vehicle number recognition apparatus T may be combined with a communication technology to upload vehicle number information obtained by capturing its surroundings in an offline situation to a general server. Thus, the vehicle number information may be used as a vehicle control service.

If a smart device is used as the vehicle number recognition apparatus T, an image processing APP and a code interpretation APP are downloaded to the smart device and configured to convert the identification code 1102 into the vehicle number information by using a vehicle pattern detection program for detecting the pattern of the vehicle C from the image data, a number plate pattern detection program for detecting the pattern of the number plate M from the pattern of the vehicle C, an edge detection program for detecting the edge area M2 of the number plate M, an image extraction program for extracting a pattern image of the identification code 1102 from the edge area M2, and an image processing program for generating number information from the pattern image. It is not necessary to provide a separate storage module, camera module, or communication module when code information conversion is performed using the smart device.

As described above, according to the vehicle number recognition system that uses a boundary code provided on an edge of a number plate in the present invention, a smart device equipped with a camera module may have an image-processing and code-interpretation APP mounted thereon to receive a vehicle-information-associated service.

The general vehicle information server S receives a vehicle number through a wired/wireless network, stores a vehicle number DB, and determines whether there is an event by comparing the vehicle number with relevant information. Here, the event may include the occurrence of a parking charge or the presence of a vehicle associated with theft or other crimes. For example, when a vehicle number is registered in the vehicle number DB as a stolen vehicle, the general vehicle information server S may immediately inform relevant agencies.

Also, the general vehicle information server S may define the identification code 1102 and support the conversion (encoding) of the vehicle number information in the number plate M into the identification code 1102.

According to the present invention, the vehicle number recognition apparatus T may directly decode the vehicle number information through the code data stored in the vehicle number recognition apparatus T, and also may perform network communication with the general vehicle information server S to receive the vehicle number information.

In the present invention, the identification code 1102 includes a pattern image. Here, the pattern image may be designed in the form of a boundary code that may be disposed in the edge area M2 of the number plate M.

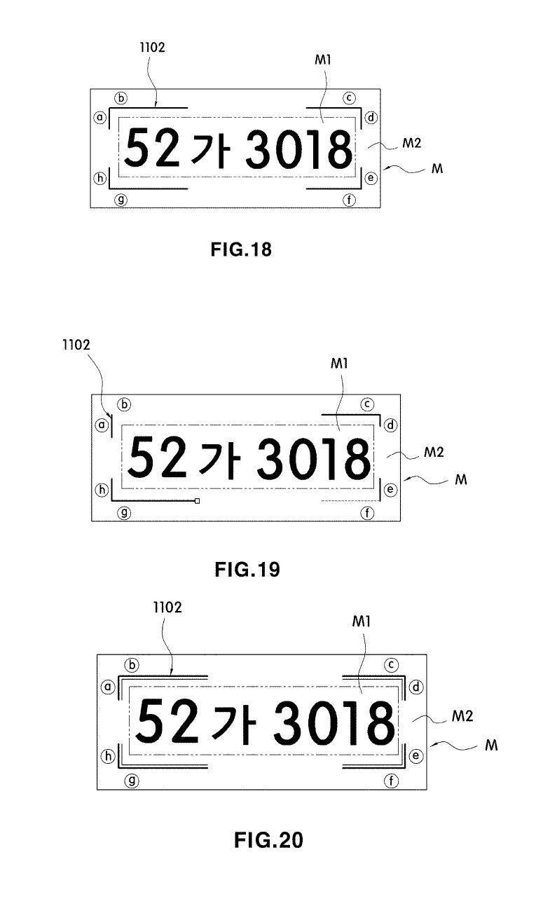

As shown in FIGS. 18 to 20, the boundary code may be placed on an edge of the number plate M, in particular, on a corner block of the number plate M, so that the pattern image does not obscure a user's view. Accordingly, the code blocks B obtained through division by the above-described area division unit 1134a may be four corner blocks.

Referring to FIG. 18, when the code block B having a certain area is divided into four corner blocks, the boundary code may be placed on a corner of the number plate M and may be designed as a character type “L” having directionality according to a position of the corner. In this case, the boundary code may be a line pattern.

Accordingly, each corner block is configured as a combination of a presence or absence of a “—” pattern and a presence or absence of a “|” pattern. Since the combination includes a case in which both the “—” pattern and the “|” pattern are present, a case in which only the “—” pattern is present, a case in which only the “|” pattern is present, and a case in which neither the “—” pattern nor the “|” pattern is present, each of the corner blocks may have two bits (2²) of information. Four corner blocks may have eight bits (2⁸) of information. Accordingly, one number plate M having four corner blocks may express 255 pieces of information by default. Some of the patterns may be used as reference points for identifying the top, the bottom, a left side, and a right side of the number plate M.

The above line pattern is expandable through pattern deformation.

Referring to FIG. 19, an identification code value may increase by further including a length, thickness, color, or type (e.g., a solid line/dotted line or a straight line/concave-convex line) of a line or a presence/position of an icon combined with a line in addition to a presence of the line.

For example, the first corner block is coded as a combination of a presence □ and an absence □ of a line, the second corner is coded as a combination of a long line □ and a short line □, the third corner is coded as a combination of a solid line □ and a dotted line □, and the fourth corner is coded as a combination of a presence □ and an absence □ of an icon. In addition, a combination of a thick line and a thin line, a combination of various color lines, or the like may be considered.

For example, when a length of a line (a long line and a short line), a type of line (a solid line and a dotted line), and a presence of an icon combined with a line (the presence or absence of the icon) in addition to a presence of the line (the presence or absence of the line) are further included, it is possible to identify a total of 32 bits (2³²=up to 4,294,967,296).

The above line pattern can be further expanded through duplication of the pattern line. Referring to FIG. 20, when the line pattern of the above-described embodiment is expanded to two lines, up to 32 bits×32 bits (2³²×2³²) of content information can be secured. Due to such an amount of information, a plurality of code combinations may be made equal to the actual number of vehicles in a country.

A system for additionally providing broadcast-associated content information using a line code provided on an edge of a screen according to the present invention will be described below.

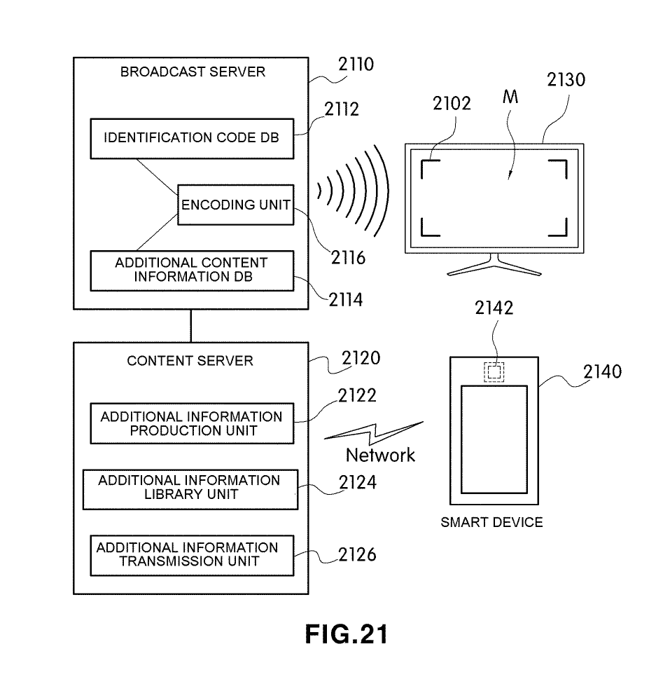

Referring to FIG. 21, a system for additionally providing broadcast-associated content information using a line code provided on an edge of a screen according to the present invention a broadcast server 2110 configured to convert (encode) additional content information into an identification code 2102, a content server 2120 configured to generate the additional content information and transmit the additional content information to the broadcast server 2110, a broadcast receiver 2130 configured to provide the identification code 2102 to four corners of a screen M, and a smart device 2140 configured to convert (decode) the identification code 2102 into content information.

The smart device 2140 is a mobile terminal such as a smart phone, a cellular phone, an iPhone, a notebook computer, etc., and may include any other terminal having various communication functions such as mobile network communication or wireless short-range communication. Here, it is assumed that a scanner or a camera module 2142 is mounted on the smart device 2140. The smart device 2140 is the same as described in FIG. 6, and the identification code interpretation APP is the same as described in FIG. 7.

Accordingly, the additional object information is a combination of characters, numbers, symbols, or pictures that may be directly recognized by a user. Alternatively, the additional object information may be a combination of spoken expressions. In the case of a drama, the additional content information may include various kinds of information associated with a writer, a PD, cast actors, props, etc.

The content server 2120 includes an additional information production unit 2122 configured to generate the additional content information, an additional information library unit 2124 configured to store the additional content information, and an additional information transmission unit 2126 configured to transmit the additional content information to the broadcast server 2110.

The broadcast server 2110 broadcasts content information corresponding to the identification code 2102 so that the additional content information may be converted into an identification code 2102. To this end, the broadcast server 2110 includes an identification code DB 2112, an additional content information DB 2114, and an encoding unit 2116 configured to convert the additional content information into an identification code.

Here, the broadcast server 2110 includes, but is not limited to, a terrestrial broadcast server, an Internet broadcast server, etc. That is, it is assumed that the broadcast is not limited only to a terrestrial broadcast and includes any broadcast relayed through a computer or a smart device or through a wireless communication network or a wired communication network such as the Internet.

In an embodiment of the present invent, the broadcast server 2110 and the content server 2120 have been described as being independent of each other, but they are not limited thereto. One server may generate the additional content information and also encode the identification code.

As described above, according to the system for providing additional information using a line code provided on an edge of a screen of the present invention, the smart device 2140 having the camera module 2142 mounted thereon may provide a service for providing the additional content information to a user who is viewing a broadcast using the identification code interpretation APP.

The present invention may directly decode the additional content information through the code data stored in the smart device 2140, and also may perform network communication with the content server 2120 to receive the additional content information from the additional information library unit 2124.

In the present invention, the identification code includes a pattern image. Here, the pattern image may be designed in the form of a line code that may be disposed in four edge areas of a screen M.

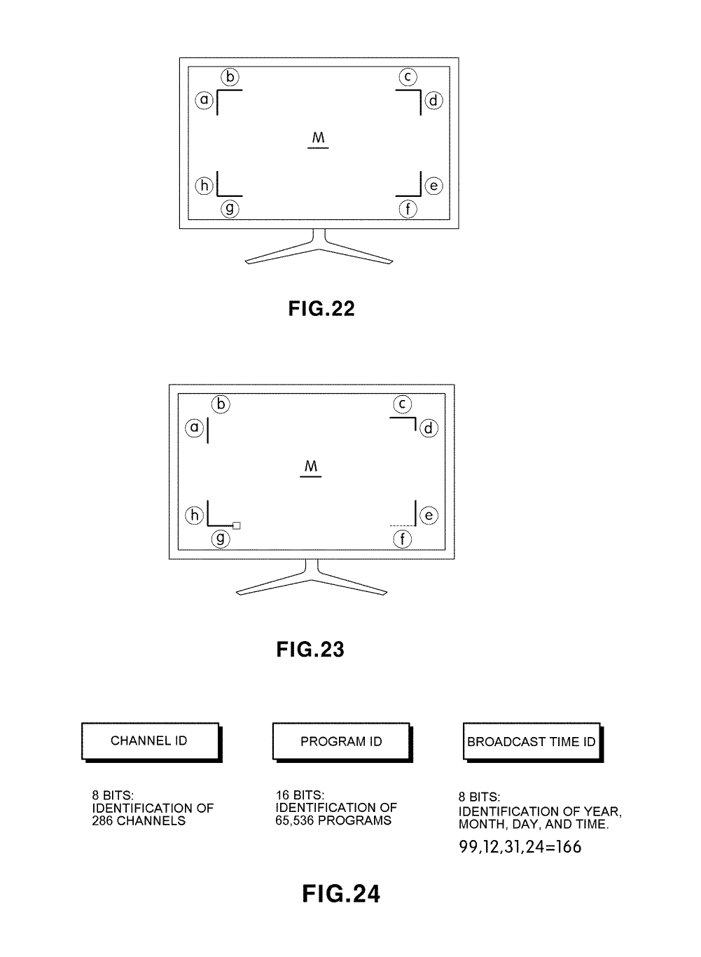

Referring to FIG. 22, the line code is placed on the four edges of the screen M and designed as a character type “L” having directionality such that the pattern image does not obscure the screen M.

Accordingly, each of the edges is configured as a combination of a presence or absence of a “—” pattern and a presence or absence of a “|” pattern. Each of the edges may have two bits (2²) of information. The four edges may have eight bits (2⁸) of information. Accordingly, one screen M having four edges may express 255 pieces of information by default.

An identification code of the above line pattern may be further expandable.

Referring to FIG. 23, an identification code value may increase by further including a length, thickness, color, or type (e.g., a solid line/dotted line or a straight line/concave-convex line) of a line or a presence/position of an icon combined with a line in addition to a presence of the line.

For example, the first edge is coded as a combination of a presence □ and an absence □ of a line, the second edge is coded as a combination of a long line □ and a short line □, the third edge is coded as a combination of a solid line □ and a dotted line □, and the fourth edge is coded as a combination of a presence □ and an absence □ of an icon. In addition, a combination of a thick line and a thin line, a combination of various color lines, or the like may be considered. Here, a length and type of line and a presence of an icon that considerably facilitates line pattern recognition will be described as an example.

For example, when the length of the line (a long line and a short line), the type of line (a solid line and a dotted line), and the presence of a combination between the line and the icon (the presence or absence of the icon) in addition to the presence of the line (the presence or absence of the line) are further included, it is possible to identify a total of 32 bits (2³²=up to 4,294,967,296).

Although not shown, when the line pattern of the above-described first expanded embodiment is expanded to two lines, up to 32 bits×32 bits (2³²×2³²) of content information can be secured. Since information of such a size is comparable to an IPv6 address, the information can be used as an Internet address.

Referring to FIG. 24, as described above, when a range of the identification code is expanded to 32 bits, the identification code can be designed for additional content identification as follows.

First, an ID may be set for each channel, an ID may be set for each program of each channel, and an ID may be set for each broadcasting time of each program.

As an example, the above-described channel ID has eight bits assigned thereto and may identify up to 255 channels, the above-described program ID has sixteen bits assigned thereto and may identify up to 65,536 programs, and the above-described broadcasting time ID has eight bits assigned thereto and may identify up to 255 areas.

A system for providing an AR service using a line code provided on an edge of an AR marker according to the present invention will be described below.

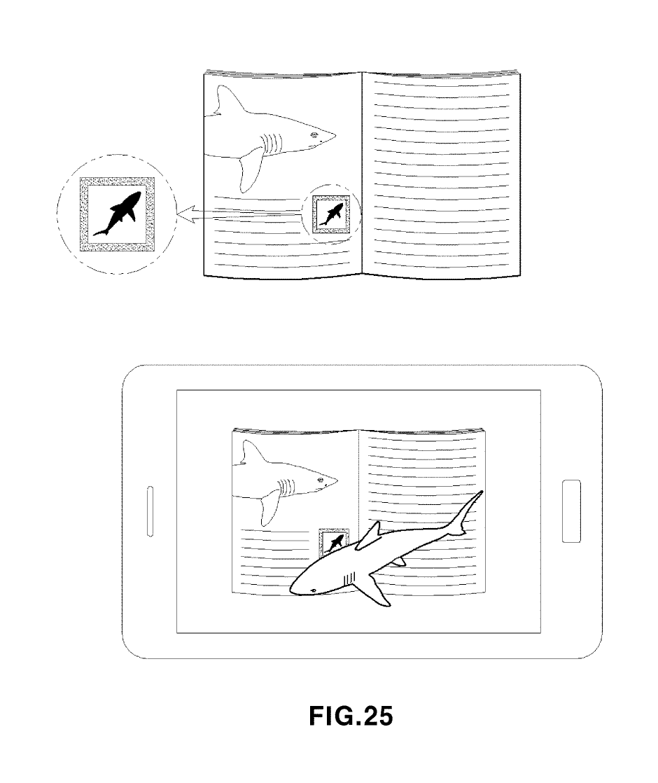

Referring to FIGS. 25 to 27, the system for providing an AR service of the present invention includes an AR marker M having an identification code 3102 provided in an edge area inside a marker frame 3104, an AR provision apparatus T configured to drive an AR APP, recognize the AR marker M, and display AR content W, and an AR provision server S configured to distribute the AR APP and provide the AR content W to the AR provision apparatus T.

Alternatively, instead of directly providing the AR marker M, the AR provision apparatus T may capture an image of the AR marker M, transmit the image to the AR provision server S, receive the AR content W from the AR provision server S after the AR provision server S recognizes the AR marker M, and display the AR content W on the AR provision apparatus T.

The AR marker M of the present invention is registered in the AR provision server S and AR text P. Here, the AR text P is an object that may be viewed by a user in the real world and includes a book or an e-book. In addition, the AR text P may include a pamphlet, a menu plate, or an advertisement plate in which a message may be delivered through paper in an off-line situation. The AR content W includes an educational video or a promotional video.

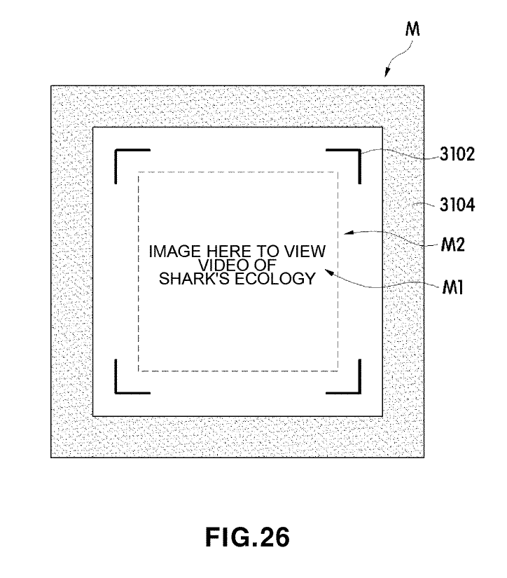

Referring to FIG. 26, the AR marker M includes the marker frame 3104 configured to indicate an AR marker and function as a reference point of the AR marker and the identification code 3102 disposed inside the marker frame 3104. Here, the marker frame 3104 may have a shape of a rectangular frame with a void space therein, and the identification code 3102 may be disposed along a boundary of the void space.

The marker frame 3104 may facilitate recognition of the identification code 3102 of the AR marker M, and may provide various parameters of the AR marker M through a thickness or length of the frame. Also, the marker frame 3104 may be a reference point that indicates a position of a virtual object to be augmented.

A middle area M1 may be provided in the void space regardless of recognition of the AR marker. The void space may be utilized in various ways. For example, several menus regarding the AR content W and having no association with the marker may be described in the void space.

For convenience, the marker frame of the present invention has been described as a rectangular frame, but this does not exclude a circular frame. When the marker frame 3104 is a triangular frame, the identification code 3102 may be placed on each corner of the frame. Also, when the marker frame 3104 is a circular frame, the identification code 3102 may be formed on an edge of the frame in the form of a circle at predetermined intervals.

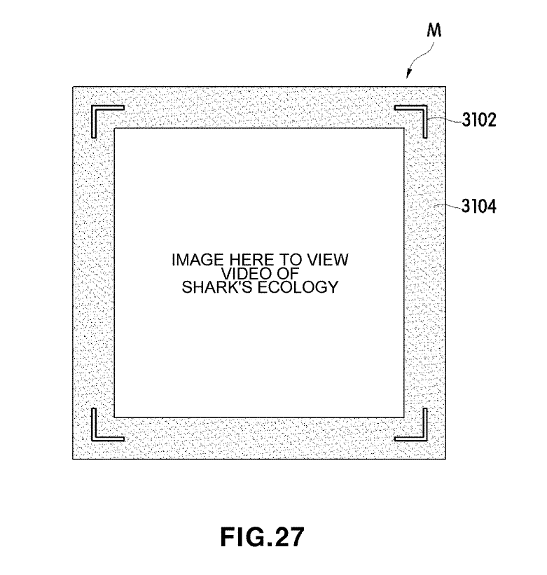

Referring to FIG. 27, the identification code 3102 may be engraved on the marker frame 3104 itself. For example, a boundary code may be directly formed on a corner of the marker frame. Alternatively, the identification code 3102 may be changed only in color and formed on the marker frame 3104.

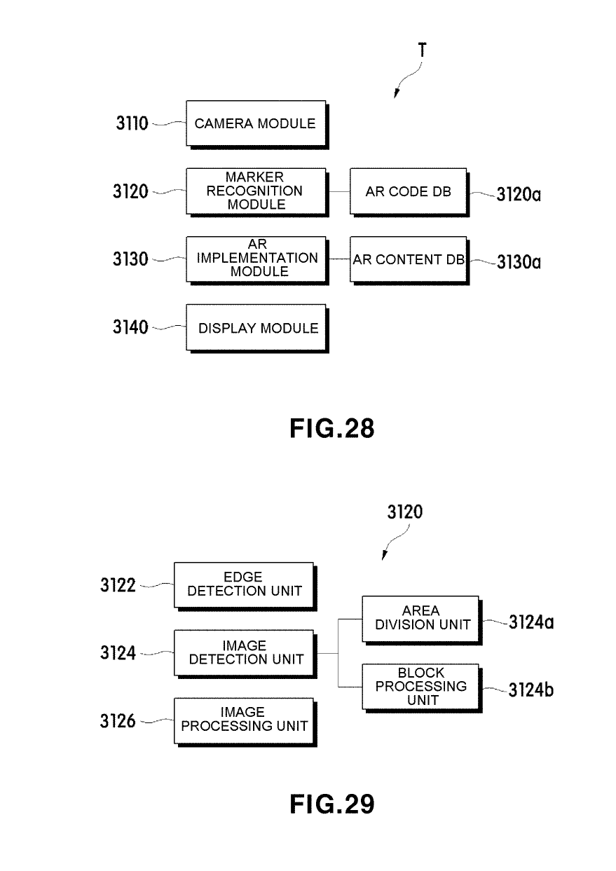

Referring to FIG. 28, the AR provision apparatus T includes a camera module 3110 configured to collect an image of the AR text P, a marker recognition module 3120 configured to recognize an AR marker M from the AR text P through the camera module 3110, an AR implementation module 3130 configured to compare the AR marker M recognized through the camera module 3110 with a marker stored in an AR code DB 3120a to determine whether the markers match, and a display module 3140 configured to display the AR content W stored in an AR content DB 3130a.

The AR code DB 3120a is described in the AR text P and configured to store AR code data. The AR content DB 3130a acquires a virtual image of a virtual object and then collects and stores the AR content W.

Although not shown, the camera module 3110 may include a lens configured to receive an optical signal for an image of the AR text P, and an image sensor configured to change the optical signal into an electric image signal needed to process the image to generate image data. In this case, when the identification code 3102 includes a color pattern, the camera module 3110 may further include a color filter array composed of an RGB filter. The image sensor may include an image camera, a web camera, or various digital cameras as well as a CCD image sensor and a CMOS image sensor.

The marker recognition module 3120 recognizes the marker frame 3104. A method of recognizing the marker frame 3104 may use a method of extracting a boundary of the marker frame 3104 and extracting a straight line from the extracted boundary. Alternatively, the marker frame recognition method may use a method of recognizing four outermost vertices of the marker frame 3104 as feature points and tracking the feature points.

Referring to FIG. 29, the marker recognition module 3120 recognizes the identification code 3102 in order to acquire maker identification information. The marker recognition module 3120 includes an edge detection unit 3122 configured to detect an edge area M2 of void space, an image extraction unit 3124 configured to acquire a pattern image of the identification code 3102 from the edge area M2 and extract the pattern image from the acquired identification code 3102, and an image processing unit 3126 configured to generate AR marker identification information from the pattern image by using the AR code DB 3120a in which AR code data corresponding to the above-described pattern image is stored. Here, the AR code data stored in the DB is a password for converting the pattern image into the AR marker identification information.

The image extraction unit 3124 includes an area division unit 3124a configured to divide the edge area M2 into code blocks (e.g., four corner blocks), and a block processing unit 3124b configured to process an identification code for each of the code blocks. Accordingly, since the edge area includes the four corner blocks and the code blocks correspond to the four corner blocks, the block processing unit 3124b processes the identification code 3102 for each of the four corner blocks.

Referring to FIG. 28 again, the AR implementation module 3130 may match the prestored AR content W to the AR content DB 3130a using the generated marker identification information and augment the AR content W on the AR marker M. For example, when it is determined that the marker identification information is matched to the AR content W stored in the AR content DB 3130a, the AR implementation module 3130 may output the AR content W to the display module 3140.

The display module 3140 includes a video unit or an audio unit that shows or tells the AR content W.

The AR provision apparatus T may be defined as a smart device having an augmented reality application (AR APP) mounted thereon. Here, the AR APP is an application distributed by an AR service provider to provide an AR service and may be distributed through an app store or a web space. For example, the AR APP is an application program that uses a developing language provided by a manufacture of an OS for a smart device to run on only a corresponding smart device, and may have various functions implemented with support of hardware functions provided by the smart device.

As an example, the smart device may include a mobile terminal such as a smartphone, a cellular phone, an iPhone, and a notebook computer. Accordingly, any terminal having various communication functions such as mobile network communication or wireless short-range communication may be included as long as a camera or a scanner is minimally provided.

The AR provision server S may store AR code data information regarding the AR marker M and AR content information regarding image information of a virtual object matching the AR code data information, and may communicate the information to the AR provision apparatus T.

In the present invention, the identification code 102 includes a pattern image. Here, the pattern image may be designed in the form of a boundary code that may be disposed in the edge area M2 of the void space.

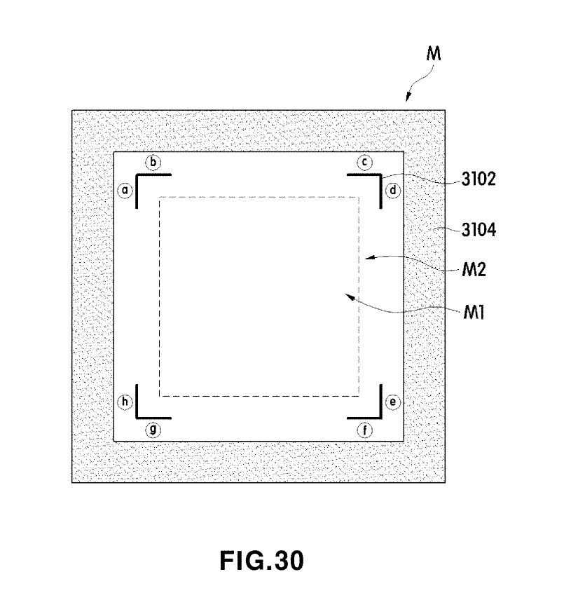

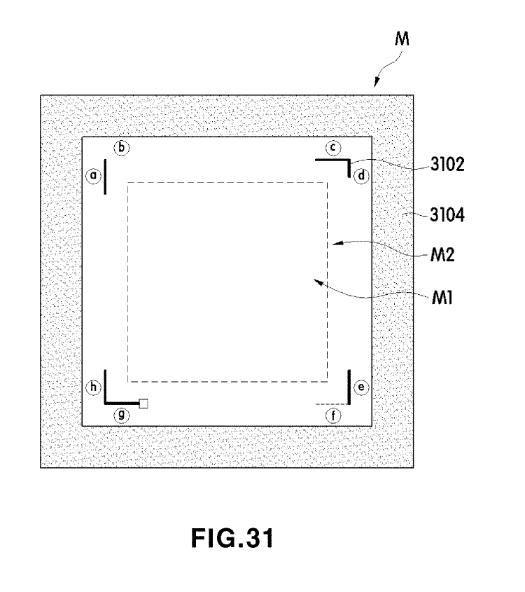

As shown in FIGS. 30 to 32, the boundary code may be placed on an edge of the void space, in particular, on a corner block of the void space, so that the pattern image does not obscure a user's view. Accordingly, as described above, four corner blocks may be the code blocks obtained through the above-described division.

Referring to FIG. 30, when a code block having a certain area is divided into four corner blocks, the boundary code may be placed on a corner of the void space and may be designed as a character type “L” having directionality according to a position of the corner. In this case, the boundary code may be a line pattern.

Accordingly, each of the corner blocks is configured as a combination of a presence or absence of a “—” pattern and a presence or absence of a “|” pattern. Since the combination includes a case in which both the “—” pattern and the “|” pattern are present, a case in which only the “—” pattern is present, a case in which only the “|” pattern is present, and a case in which neither the “—” pattern nor the “|” pattern is present, each of the corner blocks may have two bits (2²) of information. Four corner blocks may have eight bits (2⁸) of information. Accordingly, one AR marker M having four corner blocks may express 255 pieces of information by default.

Referring to FIG. 31, an identification code value may increase by further including a length, thickness, color, or type (e.g., a solid line/dotted line or a straight line/concave-convex line) of a line or a presence/position of an icon combined with a line in addition to a presence of the line.

For example, the first corner block is coded in a combination of a presence [symbol] and an absence [symbol] of a line, the second corner is coded in a combination of a long line [symbol] and a short line [symbol] , the third corner is coded in a combination of a solid line [symbol] and a dotted line [symbol] , and the fourth corner is coded in a combination of a presence [symbol] and an absence [symbol] of an icon. In addition, a combination of a thick line and a thin line, a combination of various color lines, or the like may be considered.

For example, when a length of a line (a long line and a short line), a type of line (a solid line and a dotted line), and a presence of an icon combined with a line (the presence or absence of the icon) in addition to a presence of the line (the presence or absence of the line) are further included, it is possible to identify a total of 32 bits (2³²=up to 4,294,967,296). The above line pattern can be further expanded through duplication of the pattern line.

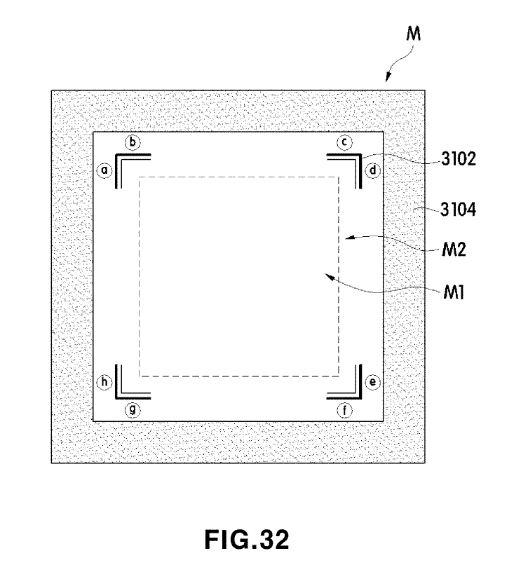

Referring to FIG. 32, when the line pattern of the above-described embodiment is expanded to two lines, up to 32 bits×32 bits (2³²×2³²) of information of the AR marker M can be secured. As described above, since many code combinations are possible depending on a presence, length, thickness, and type of pattern and a presence of an icon combined with the pattern, it is possible to even provide detailed AR content information without special limitations.

As described above, it can be seen that a technical spirit of the present invention is a configuration for easily recognizing details of a sign even at a long distance without obscuring the sign, identifying each boundary pattern according to a presence, length, thickness, and type of a pattern and an icon combined with the pattern, and providing a system for providing additional information that allows a plurality of combinations by placing a boundary pattern on an edge (a corner) area of the sign. Various modifications can be made by those skilled in the art without departing from the scope of the technical spirit of the present invention.

1. A sign including a boundary code on an edge, the sign comprising:
a sign area in which original object information is disposed; and
an edge area in which additional object information of the original object information is disposed as an identification code, wherein
the identification code of the edge area is a boundary code.

2. The sign of claim 1, wherein when the sign is a road traffic sign, the original object information is information that indicates regulations and instructions associated with road traffic, and the additional object information is road periphery information.

3. The sign of claim 1, wherein when the original object information is braille information for a visually impaired person, the additional object information is additional object information obtained by acoustically or sensately substituting visual object information.

4. The sign of claim 1, wherein the sign is polygonal, the boundary code is placed on each corner of the edge area, the boundary code includes a line pattern designed as a character type “L” having directionality according to a position of each of the corners, and the boundary code is a combination of a presence or absence of a “—” pattern and a presence or absence of a “|” pattern on each of the corners.

5. The sign of claim 4, wherein the line pattern is formed as two lines.

6. The sign of claim 1, wherein the sign is rectangular, the boundary code is placed on four corners of the edge area, the boundary code includes a line pattern designed as a character type “L” having directionality according to positions of the four corners, and the boundary code is a combination of a presence or absence of a “—” pattern and a presence or absence of a “|” pattern on the four corners.

7. The sign of claim 6, wherein the boundary code further comprises a combination of a long or short line of the “—” pattern and a long or short line of the “|” pattern.

8. The sign of claim 6, wherein the boundary code further comprises a combination of a solid or dotted line of the “—” pattern and a solid or dotted line of the “|” pattern.

9. The sign of claim 6, wherein the boundary code further comprises a combination of icons combined with the “—” pattern and the “|” pattern.

10. The sign of claim 1, wherein the sign is circular, and the boundary code is a combination of line patterns disposed in the edge region at certain intervals.

11. The sign of claim 1, wherein the boundary code includes a block pattern, and the block pattern is a combination of a plurality of blocks each having a value of “0” or “1.”

12. The sign of claim 11, wherein the sign is rectangular, the block pattern is 4-bit information, and the sign expresses additional object information of 0 to 15.

13. The sign of claim 11, wherein the sign is rectangular, the block pattern is 9-bit information, and the sign expresses additional object information of 0 to 511.

14. A system for providing additional object information using a boundary code on an edge, the system comprising:
a sign having an edge to which a boundary code is provided; and
a smart device configured to convert the boundary code into additional object information and visually, acoustically, or sensately indicate the additional object information.

15. The system of claim 14, wherein the additional object information includes object information of an Internet of things, which is acquired by a sensor or through communication.

16. The system of claim 14, further comprising an object information server configured to define the boundary code, wherein
the additional object information includes video information.

17. The system of claim 14, wherein the smart device comprises:
a camera unit configured to scan the boundary code from the sign;
a memory unit configured to store an identification code interpretation application (APP) for interpreting the boundary code into the additional object information;
a control unit configured to drive the identification code interpretation application (APP); and
a display unit configured to visually, acoustically, or sensately inform a user of the additional object information.

18. The system of claim 17, wherein the identification code interpretation application (APP) comprises:
an edge detection unit configured to detect the edge area of the sign;
an image extraction unit configured to acquire the boundary code from the edge area and extract a pattern image from the acquired boundary code;
a data storage unit configured to store code data corresponding to the pattern image; and
an image processing unit configured to generate the additional object information from the pattern image using the code data.

19. The system of claim 14, wherein:
the boundary code includes a line pattern; and
the line pattern is a combination of a presence or absence of a “—” pattern and a presence or absence of a “|” pattern.

20. The system of claim 14, wherein:
the boundary code includes a line pattern; and
the line pattern is configured as a combination of a “—” pattern and a “|” pattern and the line pattern has a character type “L” having a certain direction and is configured as various combinations depending on a presence, length, and type of the “—” pattern and the pattern and a presence of an icon combined with the “—” pattern and the “|” pattern.

21. A vehicle number recognition system comprising:
a vehicle number plate having a boundary code provided in an edge area thereof; and
a vehicle number recognition apparatus configured to convert the boundary code into original vehicle number information and store, display, or transmit the original vehicle number information to an outside.

22. The vehicle number recognition system of claim 21, wherein the boundary code is positioned on four corner blocks of the edge area, and the boundary code has an “L”-type line pattern having directionality depending on positions of the blocks and is configured as a combination of one or more of a presence, shape, thickness, and length of the line pattern.

23. The vehicle number recognition system of claim 22, wherein the vehicle number recognition apparatus comprises: an image collection module configured to collect vehicle image data; an image processing module configured process the image data to detect the number plate; and a code interpretation module configured to extract the vehicle number information from the number plate.

24. A vehicle number plate comprising:
a sign area in which original vehicle information is disposed; and
an edge area in which the original vehicle information is disposed along a boundary of the sign area in a form of an identification code, wherein
the original vehicle information is displayed on the sign area using numbers or characters, the identification code of the edge area is a boundary code, the edge area includes four corner blocks, and the boundary code is positioned on the four corner blocks.

25. The vehicle number plate of claim 24, wherein the boundary code includes a line pattern designed as an “L” type having directionality depending on positions of the four corner blocks, and the boundary code is a combination of a presence or absence of a “—” pattern and a presence or absence of a “|” pattern, which are positioned on the four corner blocks.

26. A system for providing additional content information, the system comprising:
a broadcast server configured to convert (encode) additional content information associated with a broadcast into an identification code;
a content server configured to generate the additional content information and transmit the additional content information to the broadcast server a broadcast receiver having the identification code provided on four edges of a screen; and
a smart device configured to convert (encode) the identification code into the additional content information, wherein
the smart device comprises:
a camera unit configured to scan the identification code from the screen;
a memory unit configured to store an identification code interpretation application (APP);
a control unit configured to drive the identification code interpretation application (APP); and
a display unit configured to show or tell the additional content information to a viewer, and
the identification code interpretation application (APP) comprises:
a screen edge detection unit;
an image extraction unit configured to acquire the identification code from an edge area of the screen and extract a pattern image from the acquired identification code;
a data storage unit configured to store code data corresponding to the pattern image; and
an image processing unit configured to generate the additional content information from the pattern image using the code data.

27. The system of claim 26, wherein:
the pattern image includes a line pattern; and
the line pattern is a combination of a presence or absence of a “—” pattern and a presence or absence of a “|” pattern, which are positioned on the four edges of the screen.

28. An AR provision system comprising:
an AR marker having a boundary code provided in an edge area inside a marker frame;
an AR provision apparatus configured to drive an AR APP, recognize the boundary code, and display AR content on the marker frame; and
an AR provision server configured to distribute the AR APP and provide a service for providing the AR content to the AR provision apparatus.

29. The AR provision system of claim 28, wherein the AR provision apparatus comprises:
a camera module configured to collect an image of the AR marker;
an AR marker recognition module configured to acquire AR marker identification information through the camera module;
an AR implementation module configured to output AR content information matched with the AR marker identification information; and
a display module configured to display AR content.

30. The AR provision system of claim 29, wherein the AR marker recognition module comprises:
an edge detection unit configured to detect the edge area;
an image extraction unit configured to acquire and extract a pattern image of the identification code from the edge area; and
an image processing unit configured to generate the AR marker identification information from the pattern image.

31. The AR provision system of claim 30, wherein the image extraction unit comprises:
an image division unit configured to divide the edge area into a plurality of code blocks; and
a block processing unit configured to process a boundary code for each of the code blocks, wherein
the edge area includes four corner blocks, the code blocks correspond to the four corner blocks, and the block processing unit processes the boundary code for each of the four corner blocks.

32. An AR marker comprising:
a marker frame of a rectangular frame having a void space therein; and
an identification code disposed in an edge area of the void space.

33. The AR marker of claim 32, wherein:
the identification code is a boundary code; and
the boundary code is positioned on each of four corner blocks of the edge area and configured as an “L” type line pattern having directionality depending on positions of the blocks, and the boundary code is configured as a combination of one or more of a presence, shape, thickness, and length of the line pattern.

34. The AR marker of claim 33, wherein the boundary code includes a line pattern designed as an “L” type having directionality depending on the positions of the four corner blocks, and the boundary code is a combination of a presence or absence of a “—” pattern and a presence or absence of a “|” pattern, which are positioned on the four corner blocks.
